(19) United States
(12) Patent Application Publication
(10) Pub. No.: US 2026/0245091 A1
(43) Pub. Date: Aug. 20, 2026

(54) SECURE PERSONAL IDENTIFICATION NUMBER ENTRY FOR TRANSACTIONS USING A PORTABLE ELECTRONIC DEVICE

(71) Applicant: Visa International Service Association, San Francisco, CA (US)

(72) Inventor: Yuexi Chen, Foster City, CA (US)

(73) Assignee: Visa International Service Association, San Francisco, CA (US)

(21) Appl. No.: 19/161,969

(22) PCT Filed: Mar. 17, 2023
(86) PCT No.: PCT/US2023/064609

§ 371 Date: Sep. 3, 2025

(51) Int. Cl. G06Q 20/40; G06Q 20/32

(52) U.S. Cl. CPC G06Q 20/4012; G06Q 20/3274

(57) ABSTRACT

The present disclosure provides various devices, systems, and methods for securely providing a personal identification number (PIN), securely receiving a PIN, and/or authenticating a transaction based on a securely provided PIN. In one aspect, a method for securely providing a PIN can include receiving, by a user portable electronic device, a request from a merchant portable electronic device to provide the PIN. The method can further include receiving, by a PIN entry application executed by the user portable electronic device, a user input to approve the request from the merchant portable electronic device. The method can further include generating, by the PIN entry application, an encrypted binary large object (BLOB) based on the PIN and communicating, by the user portable electronic device, the encrypted BLOB to the merchant portable electronic device.

### TECHNICAL FIELD

At least some aspects of the present disclosure relate to improving security for transactions initiated between a consumer and a merchant using a payment card (e.g., a credit card, a debit card), and more particularly, to improving security related to providing a personal identification number (PIN) for a transition initiated between a consumer and a merchant using a payment card.

### BACKGROUND

Various software applications and hardware accessories have been developed to transform off-the-shelf portable electronic devices, such as smartphones and tablets, into point-of-sale devices. For example, a point-of-sale application may be installed onto a merchant's smartphone to enable the merchant's smartphone to interact with a consumer's payment card or a consumer's smartphone to accept a contactless payment (e.g., sometimes called a Tap-to-Phone transaction (TTP)).

Using a portable electronic device as a point-of-sale device can offer various benefits. For example, portable electronic devices can be easily transported and can therefore act as mobile point-of-sale devices. Further, many merchants may already own a portable electronic device. Installing a point-of-sale application onto a portable electronic device can therefore offer merchants the ability to accept electronic payments without needing to purchase a dedicated point-of-sale device. Accordingly, a merchant may use a portable electronic device as a lower-cost and more flexible alternative to traditional point-of-sale devices.

Some payment card transactions can require that the consumer provide a personal identification number (PIN) for consumer authentication. In cases where the merchant is using a portable electronic device as a point-of-sale device, the consumer may be asked to enter the PIN on a touch screen of the merchant's portable electronic device. However, entering the PIN on a touch screen of the merchant's portable electronic device may expose the consumer to potential fraud. For example, a fraudster posing as a merchant may ask the consumer to enter the PIN on a portable electronic device that is operating a malicious application intended to look like a legitimate point-of-sale application. The malicious application may be designed to record the consumer's PIN, thereby enabling the fraudster to subsequently carry out fraudulent transactions using the PIN.

Accordingly, there is a need for devices, systems, and methods for securely providing a PIN, securely accepting the PIN, and authenticating a transaction based on the PIN. The present disclosure provides various solutions for securely providing a PIN using a portable electronic device, securing receiving the PIN using a portable electronic device, and authenticating a transaction based on the securely provided PIN.

### SUMMARY

In one aspect, the present disclosure provides a method for securely providing a personal identification number (PIN). The method can include receiving, by a user portable electronic device, a request from a merchant portable electronic device to provide the PIN. The request to provide the PIN can be based on a transaction initiated using a payment card and the merchant portable electronic device. The method can further include receiving, by a PIN entry application executed by the user portable electronic device, a user input to approve the request from the merchant portable electronic device. The method can further include generating, by the PIN entry application, an encrypted binary large object (BLOB) based on the PIN and communicating, by the user portable electronic device, the encrypted BLOB to the merchant portable electronic device. The merchant portable electronic device can be configured to communicate the encrypted BLOB to a transaction service provider server for decryption.

In another aspect, the present disclosure provides a method for authenticating a transaction. The transaction can be initiated using a payment card and a merchant portable electronic device. The transaction may require authentication based on a personal identification number (PIN). An encrypted binary large object (BLOB) generated by a user portable electronic device based on the PIN can be communicated to the merchant portable electronic device for authenticating the transaction. The method can include receiving, by a transaction service provider server, a first transaction authentication request from an acquirer server. The first transaction authentication request can include the encrypted BLOB communicated to the merchant portable electronic device. The method can further include mapping, by the transaction service provider server, the transaction to a token, retrieving a dynamic key based on the token, decrypting the encrypted BLOB to determine the PIN, and sending, by the transaction service provider server, a second transaction authentication request to an issuer server. The issuer server can determine whether to authenticate the transaction based on the PIN.

In yet another aspect, the present disclosure provides a method for securely receiving a personal identification number (PIN). The method can include reading, by a merchant portable electronic device, a payment card to initiate a transaction and determining, by a point-of-sale application executed by the merchant portable electronic device, that the transaction requires a PIN. The method can further include communicating, by the merchant portable electronic device, a request to a user portable electronic device to provide the PIN and receiving, by the merchant portable electronic device, an encrypted binary large object (BLOB) from the user portable electronic device. The user portable electronic device may generate the encrypted BLOB based on the PIN. The method can further include communicating, by the merchant portable electronic device, a transaction authorization request comprising the encrypted BLOB to a transaction service provider server for decryption.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, together with the detailed description below, are incorporated in and form part of the specification, and serve to further illustrate aspects of concepts that include the claimed disclosure and explain various principles and advantages of those aspects.

The apparatuses and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a payment network environment, according to at least one aspect of the present disclosure.

FIG. 2 is a flow diagram illustrating a transaction process for conducting a transaction based on a securely provided personal identification number (PIN), according to at least one aspect of the present disclosure.

FIGS. 3A-3C illustrate a user portable electronic device displaying user interface screens generated by a secure PIN application, according to at least one aspect of the present

FIGS. 4A-4B illustrate a merchant portable electronic device displaying merchant interface screens generated by a point-of-sale application, according to at least one aspect of the present disclosure.

FIG. 5 is a flow diagram of a method for securely providing a PIN, according to at least one aspect of the present disclosure.

FIG. 6 is a flow diagram of a method for securely receiving a PIN, according to at least one aspect of the present disclosure.

FIG. 7 is a flow diagram of a method for authenticating a transaction based on a securely provided PIN, according to at least one aspect of the present disclosure.

FIG. 8 is a block diagram of a portable electronic device, according to at least one aspect of the present disclosure.

FIG. 9 is a block diagram of a computer apparatus with data processing subsystems or components, according to at least one aspect of the present disclosure.

FIG. 10 is a diagrammatic representation of an example system that includes a host machine, according to at least one aspect of the present disclosure.

Corresponding reference characters indicate corresponding parts throughout the several views. The exemplifications set out herein illustrate various aspects of the present disclosure, in one form, and such exemplifications are not to be construed as limiting the scope of the disclosure in any manner.

### DESCRIPTION

Before explaining various forms of the vicinity use card, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof. Also in the following description, it is to be understood that terms such as “forward,” “rearward,” “left,” “right,” “above,” “below,” “upwardly,” “downwardly,” and the like are words of convenience and are not to be construed as limiting terms.

“Account credentials” may include any information that identifies an account and allows a payment processor to verify that a device, person, or entity has permission to access the account. For example, account credentials may include an account identifier (e.g., a primary account number (PAN)), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time.

An “acquirer” may refer to an entity licensed by a transaction service provider and/or approved by a transaction service provider to originate transactions (e.g., payment transactions) using a portable financial device associated with the transaction service provider. “Acquirer” or “acquirer system” may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

An “application” may include any software module configured to perform a specific function or functions when executed by a processor of a computer. For example, a “mobile application” may include a software module that is configured to be operated by a portable electronic device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. A “point-of-sale” application may include a software module that is configured to enable a portable electronic device to act as a point-of-sale device. A “PIN entry application” may include a software module that is configured to securely provide a PIN to a point-of-sale device. An “application” may be computer code or other data stored on a computer readable medium (e.g., memory element or secure element) that may be executable by a processor to complete a task.

A “payment application,” a “wallet application,” and/or a “PIN entry application” may store credentials (e.g., account identifier, expiration date, card verification value (CVV), a PIN, etc.) for accounts provisioned onto the user device. The account credentials may be stored in general memory on the portable electronic device or on a secure trusted execution environment (e.g., a secure element) of the user device. Further, in some embodiments, the account credentials may be stored by a remote computer and the payment application, wallet application, and/or PIN entry application may retrieve the credentials (or a portion thereof) from the remote computer before/during a transaction. Any number of different commands or communication protocols may be used to interface with the payment application, wallet application, and/or PIN entry application in order to obtain and use stored credentials associated with each application.

“Authentication” may refer to process by which the credential of an endpoint (including but not limited to applications, people, devices, process, and systems) can be verified to ensure that the endpoint is who they are declared to be.

A “consumer” may include an individual or a user that may be associated with one or more personal accounts and/or consumer devices. The consumer may also be referred to as a cardholder, account holder, or user.

A “cryptographic algorithm” can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc. Encryption techniques may include symmetric and asymmetric encryption techniques.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. As used herein “issuer system” or “issuer institution system” may refer to one or more systems operated by or operated on behalf of an issuer. For example, an issuer system may refer to a server executing one or more software applications associated with the issuer. In some non-limiting aspects of the present disclosure, an issuer system may include one or more servers (e.g., one or more authorization servers) for authorizing a payment transaction. An “issuer” can include a payment account issuer. The payment account (which may be associated with one or more payment devices) may refer to any suitable payment account (e.g., credit card account, a checking account, a savings account, a merchant account assigned to a consumer, or a prepaid account), an employment account, an identification account, an enrollment account (e.g., a student account), etc.

A “key” may refer to a piece of information that is used in a cryptographic algorithm to transform input data into another representation.

A “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “payment card” may refer to any device that may be used to conduct a transaction, such as a financial transaction. For example, a payment card may be used to provide payment information to a merchant. A payment card can include a substrate such as a paper, metal, or plastic card, and information that is printed, embossed, encoded, and/or otherwise included at or near a surface of the payment card. A payment card can be hand-held and compact so that it can fit into a consumer's wallet and/or pocket (e.g., pocket-sized). A payment card can be a smart card, a debit device (e.g., a debit card), a credit device (e.g., a credit card), a stored value device (e.g., a stored value card or “prepaid” card), a magnetic stripe or chip card. A payment card may operate in a contact and/or contactless mode. For example, a payment card may be an electronic payment device, such as a smart card, a chip card, an integrated circuit card, and/or a near field communications (NFC) card, among others. An electronic payment device may include an embedded integrated circuit and the embedded integrated circuit may include a data storage medium (e.g., volatile and/or non-volatile memory) to store information associated with the electronic payment device, such as an account identifier and/or a name of an account holder. A payment card may interface with an access device such as a point-of-sale device to initiate the transaction.

A “payment gateway” may refer to an entity and/or a payment processing system operated by or on behalf of such an entity (e.g., a merchant service provider, a payment service provider (PSP), a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway and/or to a payment gateway itself. The term “payment gateway mobile application” may refer to one or more electronic devices and/or one or more software applications configured to provide payment services for transactions (e.g., payment transactions, electronic payment transactions, and/or the like).

A “payment network” may refer to an electronic payment system used to accept, transmit, or process transactions made by payment devices for money, goods, or services.

The payment network may transfer information and funds among issuers, acquirers, merchants, and payment device users. One illustrative non-limiting example of a payment network is VisaNet, which is operated by Visa, Inc.

A “personal identification number” or “PIN” may refer to a numerical code or password shared between a user and a system to authenticate the user to the system. For example, a PIN may be issued or selected in association with a payment card and may be required to complete a transaction using the payment card. In some aspects, a PIN can include a range of four to six digits. A “PIN block” can be an encrypted block of data used to encapsulate a PIN. The PIN block may include the PIN, the PIN length, and a subset of the PAN.

The terms “point-of-sale system,” “POS system,” “POS terminal,” and/or “POS device” as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS devices may include portable electronic devices. For example, a portable electronic device operating a point-of-sale application can be a POS device.

A “portable electronic device” may refer to any electronic device that is portable and operated by user and/or a merchant. Examples of portable electronic devices include smartphones and other mobile phones (e.g., cellular phones), tablet computers, laptop computers, netbooks, personal music players, e-readers, hand-held specialized readers, mobile Wi-Fi devices, handheld gaming systems, navigation systems, storage devices, portable media players, wearable devices (e.g., fitness bands, smart watches, headphones, earbuds), various electronic devices included in automobiles, and any other electronic device that a user may transport, carry, and/or wear. Other portable electronic devices can include robotic devices, remote-controlled devices, personal-care appliances, and so on.

A “primary account number (PAN)” may be a variable length, (e.g. 13 to 19-digit) industry standard-compliant account number that is generated within account ranges associated with a bank identification number (BIN) by an issuer.

“Provisioning” may include a process of providing data for use. For example, provisioning may include providing, delivering, or enabling a token on a device. Provisioning may be completed by any entity within or external to the transaction processing system. For example, in some embodiments, tokens may be provisioned by an issuer or a payment processing network onto a portable electronic device of a consumer (e.g., account holder).

The provisioned tokens may have corresponding token data stored and maintained in the token vault or token registry. In some embodiments, a token vault or token registry may generate a token that may then be provisioned or delivered to a device. In some embodiments, an issuer may specify a token range from which token generation and provisioning can occur. Further, in some embodiments, an issuer may generate and notify a token vault of a token value and provide the token record information (e.g., token attributes) for storage in the token vault.

A “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system.

Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

Reference to “a device,” “a server,” “a processor,” and/or the like, as used herein, may refer to a previously recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

A “system” may refer to one or more computing devices or combinations of computing devices (e.g., processors, servers, client devices, software applications, components of such, and/or the like).

A “token” may refer to an account identifier that is used as a substitute or replacement for another account identifier, such as a PAN. Tokens may be associated with a PAN or other original account identifier in one or more data structures (e.g., one or more databases and/or the like) such that they may be used to conduct a payment transaction without directly using the original account identifier. In some non-limiting embodiments or aspects, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes. A token may be a substitute value for a credential. A token may be a string of numbers, letters, or any other suitable characters. Examples of tokens include payment tokens, access tokens, personal identification tokens, etc.

A “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions.

As used herein “transaction service provider system” may refer to one or more systems operated by or operated on behalf of a transaction service provider, such as a transaction service provider system executing one or more software applications associated with the transaction service provider. In some non-limiting embodiments or aspects, a transaction service provider system may include one or more server computers with one or more processors and, in some non-limiting embodiments or aspects, may be operated by or on behalf of a transaction service provider.

A “user” may include an individual. In some embodiments or aspects, a user may be associated with one or more personal accounts and/or mobile devices. The user may also be referred to as a cardholder, account holder, or consumer.

As described above, various software applications and hardware accessories have been developed to transform portable electronic devices into point-of-sale devices. However, entering a personal identification number (PIN) on a touch screen of a merchant's portable electronic device to authorize a transaction may expose a consumer to potential fraud. For example, a fraudster posing as a merchant may ask the consumer to enter the PIN on a portable electronic device that is operating a malicious application intended to look like a legitimate point-of-sale application. The malicious application may be configured to record the consumer's PIN, thereby enabling the fraudster to subsequently carry out fraudulent transactions using the PIN. Accordingly, there is a need for devices, systems, and methods for securely providing a PIN, securely accepting the PIN, and authenticating a transaction based on the PIN.

The present disclosure provides various devices, systems, and methods for securely providing a PIN using a user portable electronic device, securing accepting the PIN using a merchant portable electronic device, and/or authenticating a transaction based on the securely provided PIN. For example, a method for securely providing a PIN using a user portable electronic device can include receiving, by the user portable electronic device, a request from the merchant portable electronic device to provide the PIN. The request can be based on a transaction initiated using a payment card and the merchant portable electronic device. A PIN entry application executed by the user portable electronic device can receive a user input to approve the request. Based on the approval, the PIN entry application can generate an encrypted binary large object (BLOB) based on the PIN. The user portable electronic device can communicate the encrypted BLOB to the merchant portable electronic device. The merchant portable electronic device can be configured to communicate the encrypted BLOB to a transaction service provider server (e.g., via an acquirer server) for decryption.

The devices, systems, and methods provided herein can provide numerous benefits. For example, the devices, systems, and methods eliminate the need for the user to manually enter the PIN to merchant portable electronic device. Further, although the encrypted BLOB generated based on the PIN is communicated to the merchant portable electronic device, the merchant portable electronic device may not be configured to decrypt the encrypted BLOB. Thus, the merchant, or a fraudster posing as a legitimate merchant, may not be able to maliciously obtain the PIN. Yet further, the encrypted BLOB can be forwarded by the merchant portable electronic device to the transaction service provider server for decryption, allowing the transaction service provider server to determine whether the correct PIN has been provided. Accordingly, the devices, systems, and methods provided herein can retain the security-related benefits to employing PIN-protected transactions.

As another example, unlike some currently available wallet and payment applications, the PIN entry application can be configured to not require that the user portable electronic device support near field communication (NFC), Bluetooth communication, and/or biometric authentication. Thus, many of the currently available off-the-shelf smartphones and tablets can use the PIN entry application.

As yet another example, the devices, systems and methods provided herein can be compliant with currently employed messaging standards between payment gateway servers, acquirer servers, transaction service provider servers, and issuer servers. For example, the encrypted BLOB can be configured according to International Organization for Standardization (ISO) PIN block format. Thus, the devices, systems and methods provided herein can be implemented without modifying existing messaging standards.

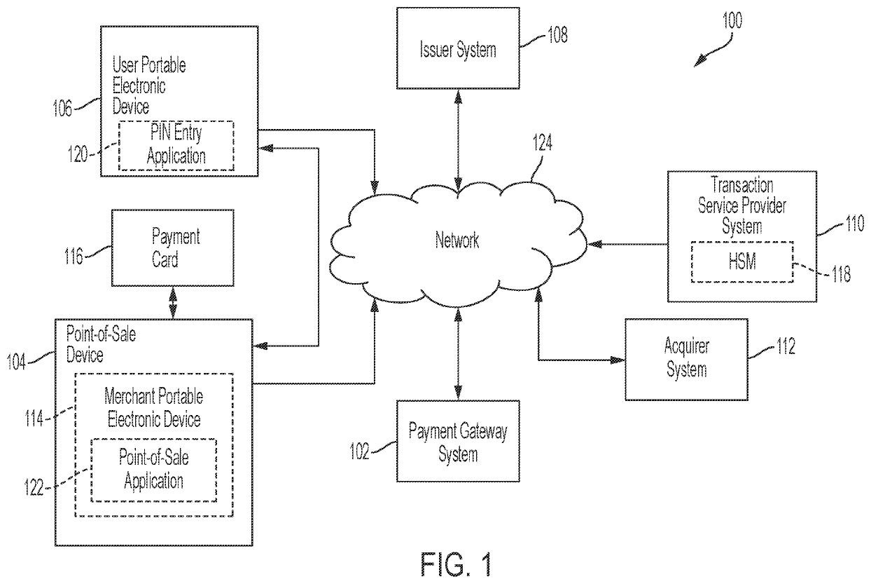

FIG. 1 is a diagram of a payment network environment 100 in which a transaction may be conducted based on a securely provided PIN, according to at least one aspect of the present disclosure. As shown in FIG. 1, the payment network environment 100 can include payment gateway system 102, a point-of-sale (POS) device 104, a user portable electronic device 106, an issuer system 108, a transaction service provider system 110, an acquirer system 112, a network 124, and a payment card 116. The payment gateway system 102, the POS device 104, the user portable electronic device 106, the issuer system 108, the transaction service provider system 110, and/or the acquirer system 112 may interconnect (e.g., establish a connection to communicate) via wired connections, wireless connections, or a combination of wired and wireless connections.

The payment gateway system 102 may include one or more devices capable of receiving information from and/or transmitting information to the POS device 104, the user portable electronic device 106, the issuer system 108, the transaction service provider system 110, and/or the acquirer system 112 via the network 124. For example, the payment gateway system 102 may include a computing device, such as a server (e.g., a transaction processing server), a group of servers, and/or other like devices.

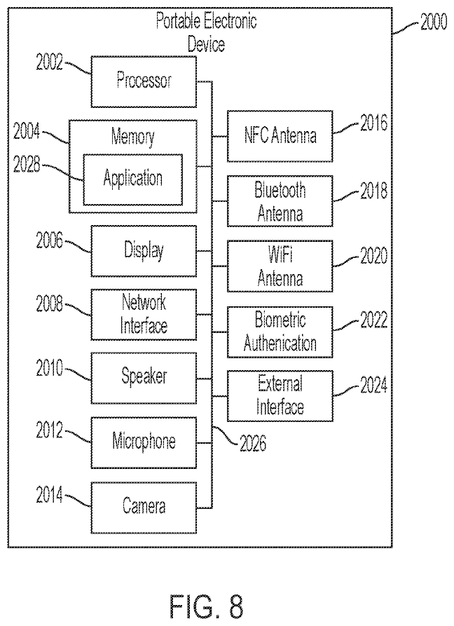

The POS device 104 may include one or more devices capable of receiving information from and/or transmitting information to the payment gateway system 102, the user portable electronic device 106, the issuer system 108, the transaction service provider system 110, and/or the acquirer system 112 via the network 124. In some aspects, the POS device 104 may include a merchant portable electronic device 114, which may be similar to the portable electronic device 2000 of FIG. 8. The merchant portable electronic device 114 can include a processor and a memory. The memory can store a point-of-sale application 122 executable by the processor to enable the merchant portable electronic device 114 to function as the POS device 104. The POS device 104 can be configured to receive information from the user portable electronic device 106 and/or the payment card 116 via a communication connection (e.g., a near field communication (NFC) connection, a radio-frequency identification (RFID) communication connection, a Bluetooth® communication connection, and/or the like) and/or transmit information to the user portable electronic device 106 and/or the payment card 116 via the communication connection. In some aspects, the POS device 104 may be a component of a merchant system associated with a merchant, as described herein. In some aspects, the POS device 104 may include one or more than one device, such a computer, a computer system, a portable electronic device, and/or a peripheral device capable of being used by a merchant to conduct a payment transaction with a user using the user portable electronic device 106 and/or the payment card 116.

The user portable electronic device 106 may include one or more devices capable of receiving information from and/or transmitting information to the payment gateway system 102, the POS device 104, the issuer system 108, the transaction service provider system 110, and/or the acquirer system 112 via the network 124. In some aspects, the user portable electronic device 106 may be similar to the portable electronic device 2000 of FIG. 8. The user portable electronic device 106 can include a processor and a memory. The memory can store a PIN entry application 120 executable by the processor to enable the user portable electronic device 106 securely provide a PIN to the POS device 104 for approving a transaction. The user portable electronic device 106 can be configured to receive information from the POS device 104 via a communication connection (e.g., a near field communication (NFC) connection, a radio-frequency identification (RFID) communication connection, a Bluetooth® communication connection, and/or the like) and/or transmit information to the POS device 104 via the communication connection. The user portable electronic device 106 can include a display screen configured to display information (e.g., a quick response (QR) code) that is readable by a camera or other type of sensor of the POS device 104 (e.g., a camera or other type of sensor of the merchant portable electronic device 114). The user portable electronic device 106 can include a speaker configured to generate a sound comprising information that is detectable by a microphone or other type of sensor of the POS device 104 (e.g., a microphone or other type of sensor of the merchant portable electronic device 114).

The issuer system 108 may include one or more devices capable of receiving information from and/or transmitting information to payment gateway system 102, the POS device 104, the user portable electronic device 106, transaction service provider system 110, and/or the acquirer system 112 via the network 124. For example, issuer system 108 may include a computing device, such as a server, a group of servers, and/or other like devices. In various aspects, the issuer system 108 may be associated with an issuer institution. For example, the issuer system 108 may be associated with an issuer institution that issued a credit account, debit account, credit card account, debit card account, and/or the like to a user associated with the payment card 116.

The transaction service provider system 110 may include one or more devices capable of receiving information from and/or transmitting information to the payment gateway system 102, the POS device 104, the user portable electronic device 106, the issuer system 108, and/or the acquirer system 112 via the network 124. For example, the transaction service provider system 110 may include a computing device, such as a server (e.g., a transaction processing server), a group of servers, and/or other like devices. In some aspects, the transaction service provider system 110 may be associated with a transaction service provider. In some aspects, transaction service provider system 110 may be in communication with a data storage device, which may be local or remote to the transaction service provider system 110. In some aspects, the transaction service provider system 110 may be capable of receiving information from, storing information in, transmitting information to, or searching information stored in a data storage device. The transaction service provider system 110 may include a hardware security module (HSM) 118. The HSM 118 can be a hardware device or computer configured to provide safeguards for storing, using, and/or generating security and cryptographic information such as, keys, digital certificates, passwords, passphrases, two-factor authentication information, PIN, tokens, and/or similar security and cryptographic information. In some aspects, the HSM 118 can be employed to generate, manage, and/or store keys. The HSM 118 may be configured as one or more than one stand-alone network computer and/or as one or more than one hardware card that may be added to a computer.

The acquirer system 112 may include one or more devices capable of receiving information from and/or transmitting information to the payment gateway system 102, the POS device 104, the user portable electronic device 106, the issuer system 108, and/or the transaction service provider system 110 via the network 124. For example, the acquirer system 112 may include a computing device, such as a server, a group of servers, and/or other like devices. In some aspects, acquirer system 112 may be associated with an acquirer. In some aspects, the acquirer system 112 may be associated with a merchant account of a merchant associated with the POS device 104.

The network 124 may include one or more wired and/or wireless networks. For example, the network 124 may include a cellular network (e.g., a long-term evolution (LTE) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices, systems, and networks shown in the payment network environment 100 of FIG. 1 are provided as an example. There may be additional devices, systems, and/or networks, fewer devices, systems, and/or networks, different devices, systems, and/or networks, or differently arranged devices, systems, and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of the payment network environment 100 may perform one or more functions described as being performed by another set of devices of the payment network environment 100.

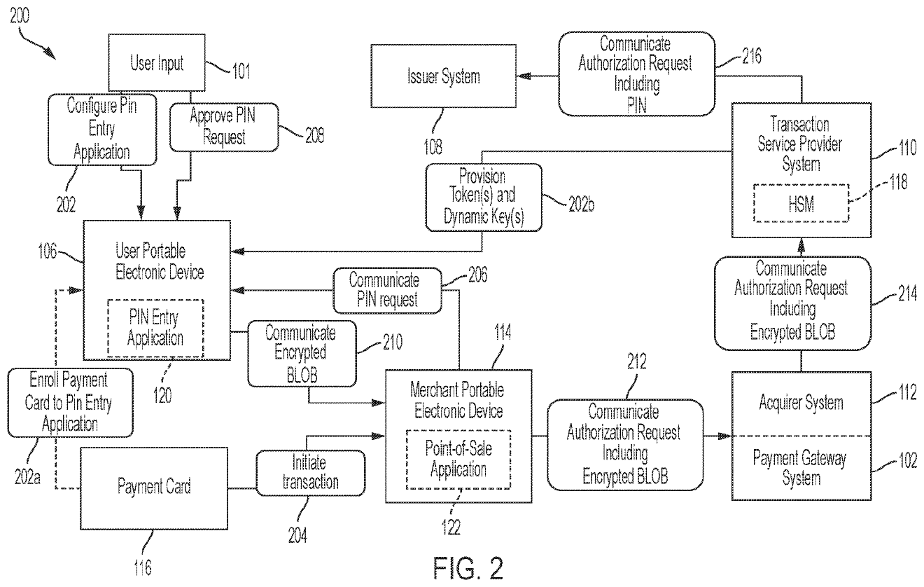

FIG. 2 is a diagram illustrating a transaction process 200 for conducting a transaction based on a securely provided PIN, according to at least one aspect of the present disclosure. The transaction process 200 can be carried out across the payment network environment 100 described herein with respect to FIG. 1.

Referring primarily to FIG. 2, and also to FIG. 1, according to the transaction process 200, a user input 101 can cause the user portable electronic device 106 to configure 202 the PIN entry application 120. For example, based on receiving the user input 101, the user portable electronic device 106 can download the PIN entry application via the network 124 and install the PIN entry application 120. As another example, the PIN entry application 120 may already be installed on the portable electronic device 106. Thus, based on receiving the user input 101, the user portable electronic device 106 can execute and/or open the PIN entry application 120. Configuring 202 the PIN entry application 120 can further include enrolling 202a the payment card 116 to the PIN entry application 120. For example, the user input 101 may include various account credentials associated with the payment card 116 (e.g., an account identifier, an expiration date, a verification value, a PIN, etc.) that enable the PIN entry application 120 to recognize the payment card 116, verify that the payment card 116 is associated with the user, and/or store the account credentials associated with the payment card 116 to the memory of the user portable electronic device 106. In some aspects, the PIN entry application 120 recognizes the payment card 116, verifies that the payment card 116 is associated with the user, and/or stores the account credentials associated with the payment card 116 based on the user input 101 and a communication with the issuer system 108 and/or the transaction service provider system 110.

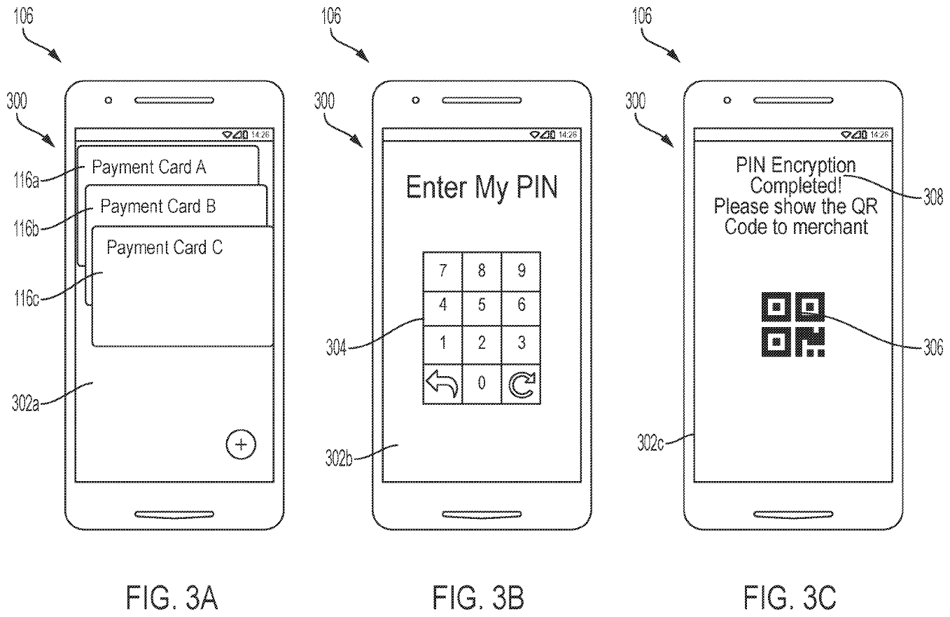

One or more than one payment card 116 can be enrolled 202a to the PIN entry application 120. The PIN entry application 120 can be configured to cause a display screen of the user portable electronic device 106 to display a user interface including an image corresponding to each of the one or more than one payment cards 116 enrolled 202a to the PIN entry application 120. For example, FIG. 3A illustrates a display screen 300 of the user portable electronic device 106 displaying a user interface 302a generated by the PIN entry application 120. The user interface 302a may include images corresponding to more than one payment card 116 (e.g., payment card 116a, payment card 116b, payment card 116c), which can indicate that each of the more than one payment card 116 is enrolled to the PIN entry application 120. In some aspects, the user can select one of the images to view and/or edit various information related to enrollment of the corresponding payment card 116.

Referring again primarily to FIG. 2, and also to FIG. 1, according to some aspects of the present disclosure, the PIN entry application 120 can be configured to store a PIN for at least some of the one or more than one payment card 116 that is enrolled 202a. Further, the PIN entry application 120 can be configured to enable the user to retrieve a stored PIN. In some aspects, the PIN entry application 120 can be configured to require the user to provide a password and/or a biometric authentication in order to retrieve the stored PIN. For example, as noted above, more than one payment card 116 may be enrolled 202a to the PIN entry application 120. The PIN entry application 120 can be configured to enable the user to set up a master PIN and/or password. The master PIN and/or password can be different than stored PINs associated with each enrolled 202a payment card 116. The PIN entry application 120 can allow the user to access the stored PINs in response to the user providing the master PIN and/or stored password. As another example, the PIN entry application 120 can be configured to enable the user to require that user biometric authentication be provided in order to access the stored PINs. After the user choses to require biometric authentication, the PIN entry application 120 can be configured to allow the user to access the stored PINs in response to the user providing biometric authentication (e.g., via a fingerprint scan, via a facial scan).

Referring still primarily to FIG. 2, and also to FIG. 1, according to the transaction process 200, the transaction service provider system may provision 202b one or more than one token and one or more than one dynamic key to the PIN entry application 120. For example, the transaction service provider system may provision 202b a token for each payment card 116 that is enrolled 202a the PIN entry application 120. Each token can correspond to a personal account number (PAN) associated with the respective payment card 116. Further, the transaction service provider system may provision 202b one or more than one dynamic key for each of the provisioned 202b tokens. As explained further herein, the token(s) and dynamic key(s) can be used by the PIN entry application 120 to encrypt a PIN associated with the payment card 116. The token(s) and dynamic key(s) can be used by the transaction services provider system 110 to decrypt the encrypted PIN. The dynamic key(s) can be symmetric (e.g., encrypted and decrypted by a symmetric cryptographic algorithm).

Referring still primarily to FIG. 2, and also to FIG. 1, according to the transaction process 200, the user and/or a merchant may initiate 204 a transaction using the payment card 116 and the merchant portable electronic device 114. For example, the user may initiate 204 a tap-to-phone (TTP) transaction by tapping or otherwise holding the payment card proximate to the merchant portable electronic device 114. Further, a point-of-sale application 122 executed by the merchant portable electronic device 114 can be configured to cause the merchant portable electronic device 114 to read the payment card 116 in response to the user tapping or otherwise holding the payment card proximate to the merchant portable electronic device 114. In other aspects, the transaction can be initiated 204 via methods that are not contactless. For example, the user may initiate 204 the transaction by swiping a magnetic stripe of the payment card 116 across a card reader hardware accessory connected to the merchant portable electronic device 114.

In some aspects of the transaction process 200, the initiated 204 transaction may not require a PIN in order to proceed. In this aspect, the point-of-sale application 122 can be configured to cause the merchant portable electronic device 114 to communication an authorization request to the acquirer system 112 and/or the payment gateway system 102. The transaction process 200 can proceed thereafter according to known methods, either approving or denying the initiated transaction.

In other aspects of the transaction process 200, the initiated 204 transaction may require a PIN in order to proceed. For example, a value of the initiated 204 transaction may satisfy a predetermined threshold, thereby triggering the requirement for a PIN in order to proceed. As another example, the initiated 204 transaction may require strong customer authentication (SCA) and therefore require a PIN.

In one aspect, where the initiated 204 transaction requires a PIN in order to proceed, the point-of-sale application 122 can be configured to provide a notification to the merchant that prompts the merchant to communicate 206 a PIN request to the user (e.g., prompting the merchant to ask the user to provide a PIN). In response, the user may open the PIN entry application 120 on the user portable electronic device 106. If the user wishes to proceed with the transaction, the user may provide a user input 101 to the PIN entry application 120 to approve 208 the PIN request.

In another aspect, where the initiated 204 transaction requires a PIN in order to proceed, the point-of-sale application 122 can be configured to communicate 206 (e.g., transmit) a PIN request directly to the PIN entry application 120 of the user portable electronic device 106. In response, the PIN entry application 120 can be configured to prompt the user to either approve or deny the PIN request. If the user wishes to proceed with the transaction, the user may provide a user input 101 to the PIN entry application 120 approving 208 the PIN request.

According to some aspects of the transaction process 200, the user input 101 approving 208 the PIN request can include the user typing or otherwise providing the PIN to the PIN entry application via a user interface generated by the user portable electronic device 106. For example, FIG. 3B illustrates a display screen 300 of the user portable electronic device 106 displaying a user interface 302b generated by the PIN entry application 120. The user interface 302b includes a keypad 304. The user may provide the PIN via the keypad 304. This method of approving 208 the PIN request may be applied, for example, in cases where the PIN corresponding to the payment card 116 is not already stored by the PIN entry application 120.

Referring again primarily to FIG. 2, and also to FIG. 1, in another aspect, the user input 101 approving 208 the PIN request can include the user providing the master PIN and/or password described further above. In yet another aspect, the user input 101 approving 208 the PIN request can include the user providing the biometric authentication described further above. These methods of approving 208 the PIN request may be applied, for example, in cases where the PIN corresponding to the payment card 116 is stored by the PIN entry application 120.

Referring still primarily to FIG. 2, and also to FIG. 1, in response to receiving the user input 101 approving 208 the PIN request, the PIN entry application 120 can be configured to generate an encrypted binary large object (BLOB) based on the PIN. The encrypted BLOB can be generated based on the token(s) and dynamic key(s) provisioned 202b by the transaction service provider system 110. For example, the PIN entry application 120 can identify a token associated with the payment card 116. The PIN entry application 120 can then identify the dynamic key(s) associated with the payment card 116 based on the token. The PIN entry application 120 can employ a cryptographic algorithm to transform the PIN to the encrypted BLOB based on the identified dynamic key(s). In some aspects, the token can be associated with multiple dynamic keys. Based on a counter that cycles through the multiple dynamic keys, the PIN entry application 120 can select one of the multiple dynamic keys and generate the encrypted BLOB based on the selected dynamic key. In other aspects, the token can be associated with one dynamic key. The PIN entry application 120 can generate a unique session key based on the dynamic key (e.g., based on a counter and the dynamic key) and then generate the encrypted BLOB based on the session key. In some aspects, the encrypted BLOB is configured according to International Organization for Standardization (ISO) PIN block format.

Referring still primarily to FIG. 2, and also to FIG. 1, according to the transaction process 200, the PIN entry application 120 can be configured to cause the user portable electronic device 106 to communicate 210 the encrypted BLOB to the point-of-sale application 122 of the merchant portable electronic device 114.

According to some aspects of the transaction process 200, communicating 210 the encrypted BLOB to the merchant portable electronic device 114 can include generating, by the PIN entry application 120, a quick response (QR) code based on the encrypted BLOB. The QR code can be displayed by a display screen of the user portable electronic device 106. For example, FIG. 3C illustrates a display screen 300 of the user portable electronic device 106 displaying a user interface 302c that includes a QR code 306 generated by the PIN entry application 120. The display screen 300 is also displaying a notification 308 prompting the user to show the QR code 306 to the merchant.

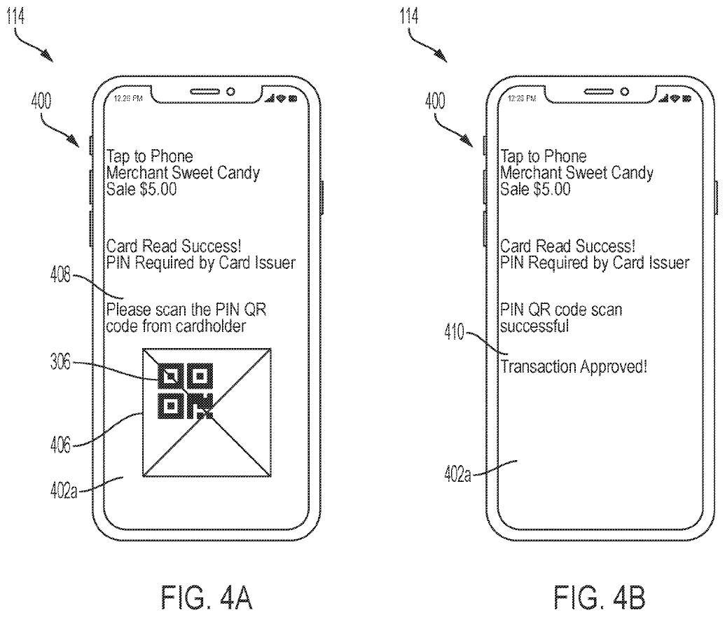

Referring again to FIG. 2, the point-of-sale application 122 can be configured to cause the merchant portable electronic device 114 to read the QR code displayed by the user portable electronic device 106. For example, FIG. 4A illustrates a display screen 400 of the merchant portable electronic device 114 displaying a merchant interface 402a generated by the merchant portable electronic device 114. The merchant interface 402a includes a live image 406 captured by a camera of the merchant portable electronic device 114. The live image 406 shows the QR code 306 displayed the by display screen 300 of the user portable electronic device 106 (FIG. 3), for example, as the merchant points the field of view of the camera toward the display screen 300. The merchant interface 402a may also include a notification 408 prompting the merchant to scan the QR code 306. Based on reading the QR code, the point-of-sale application 122 can receive the encrypted BLOB.

Referring again primarily to FIG. 2, and also to FIG. 1, according to other aspects of the transaction process 200, communicating 210 the encrypted BLOB to the merchant portable electronic device 114 can include generating, by the PIN entry application 120, a near field communication (NFC) data exchange format message comprising the encrypted BLOB. The PIN entry application 120 can cause the user portable electronic device 106 (e.g., a NFC radio of the user portable electronic device 106) to transmit the NFC data exchange format message comprising the encrypted BLOB to the merchant portable electronic device 114. The point-of-sale application 122 may cause the merchant portable electronic device 114 (e.g., a NFC radio of the merchant portable electronic device 114) to receive the NFC data exchange format message. Based on receiving the NFC data exchange format message, the point-of-sale application 122 can receive the encrypted BLOB.

According to yet other aspects of the transaction process 200, communicating 210 the encrypted BLOB to the merchant portable electronic device 114 can include generating, by the PIN entry application 120, a sound comprising the encrypted BLOB. The PIN entry application 120 can cause the user portable electronic device 106 (e.g., speaker of the user portable electronic device 106) to transmit the sound comprising the encrypted BLOB to the merchant portable electronic device 114. The point-of-sale application 122 may cause the merchant portable electronic device 114 (e.g., a microphone or other sensor of the merchant portable electronic device 114) to detect and/or read the sound. Based on detecting and/or reading the sound, the point-of-sale application 122 can receive the encrypted BLOB.

According to yet other aspects of the transaction process 200, communicating 210 the encrypted BLOB to the merchant portable electronic device 114 can include generating, by the PIN entry application 120, a Bluetooth message (e.g., a name card) comprising the encrypted BLOB or a WiFi message (e.g., a WiFi direct message) comprising the encrypted BLOB. The PIN entry application 120 can cause the user portable electronic device 106 (e.g., a Bluetooth module or a WiFi module of the user portable electronic device 106) to transmit the Bluetooth message comprising the encrypted BLOB or a WiFi message comprising the encrypted BLOB to the merchant portable electronic device 114. The point-of-sale application 122 may cause the merchant portable electronic device 114 (e.g., a Bluetooth module or a WiFi module of the merchant portable electronic device 114) to receive the Bluetooth message or the WiFi message. Based on receiving the Bluetooth message or the WiFi message, the point-of-sale application 122 can receive the encrypted BLOB.

Although the point-of-sale application 122 receives the encrypted BLOB, the merchant cannot see or detect the user's actual PIN. Further, the point-of-sale application 122 may not be able to decrypt the encrypted BLOB to determine the PIN. Thus, the merchant, or a fraudster posing as a merchant and executing a malicious application intended to look like a legitimate point-of-sale application, is prevented from obtaining the user's PIN and subsequently conducting a fraudulent transaction with the PIN. However, as explained further herein, the encrypted BLOB can be decrypted by the transaction service provider system 110 to determine whether to authorize the transaction. Accordingly, the user can be protected from fraud both by the requirement to provide the PIN to authorize the transaction and by the use of the encrypted BLOB to prevent the merchant from obtaining the user's actual PIN.

Referring still primarily to FIG. 2, and also to FIG. 1, according to the transaction process 200, the point-of-sale application 122 can be configured to cause the merchant portable electronic device to communicate 212 an authorization request to the payment gateway system 102 and/or the acquirer system 112. For example, the authorization request may be communicated to the payment gateway system 102 and then forwarded by the payment gateway system 102 the acquirer system 112. As another example, the authorization request may be communicated 212 directly to the acquirer system 112. The authorization request communicated 212 to the payment gateway system 102 and/or the acquirer system 112 can include the encrypted BLOB and may also include various other data related to the transaction, such as transaction data configured according to Europay Mastercard Visa (EMV) standards. As noted above, the encrypted BLOB can be configured according to International Organization for Standardization (ISO) PIN block format. Thus, the authorization request communicated 212 to the payment gateway system 102 and/or the acquirer system 112 can be compliant with payment network communication standards that are currently in use.

Referring still primarily to FIG. 2, and also to FIG. 1, according to the transaction process 200, based on receiving the authorization request communicated 212 by the point-of-sale application 122, the acquirer system 112 can communicate 214 an authorization request to the transaction service provider system 110. The authorization request communicated 214 to the transaction service provider system 110 can include the encrypted BLOB and may also include various other data related to the transaction, such as transaction data configured according to Europay Mastercard Visa (EMV) standards. The encrypted BLOB can be configured according to International Organization for Standardization (ISO) PIN block format. Thus, the authorization request communicated 214 to the transaction service provider system 110 can be compliant with payment network communication standards that are currently in use.

Referring still primarily to FIG. 2, and also to FIG. 1, based on receiving the authorization request communicated 214 by the acquirer system 112, the transaction service provider system 110 can determine whether the authorization request includes an encrypted BLOB. For example, transaction data included in the authorization request may include an identifier indicating that that the transaction is a tap-to-phone (TTP), thereby indicating that an encrypted BLOB is included in the authorization request. If the transaction service provider system 110 determines that the authorization request does not include an encrypted BLOB, then the transaction service provider system 110 can process the authorization request according to existing methods. If the transaction service provider system 110 determines that the authorization request does include an encrypted BLOB, then the transaction service provider system 110 can decrypt the encrypted BLOB as explained further herein.

Referring still primarily to FIG. 2, and also to FIG. 1, according to the transaction process 200, to decrypt the encrypted BLOB, the transaction service provider system 110 can be configured extract a personal authentication number (PAN) from the authorization request communicated by the acquirer system 112. Further, the transaction service provider system 110 can be configured to map the PAN to a token. For example, transaction service provider system 110 can map the PAN to the token that was provisioned 202b to the PIN entry application 120. The transaction service provider system 110 can then identify one or more than one dynamic key associated with the token to which the PAN was mapped. For example, the transaction service provider system 110 can identify and retrieve the dynamic key(s) provisioned 202b to the PIN entry application. The transaction service provider system 110 can employ a cryptographic algorithm to decrypt the encrypted BLOB based on the retrieved dynamic keys(s) to determine the PIN.

As noted above, the dynamic key(s) can be symmetric. Thus, the same dynamic key(s) used by the PIN entry application 120 to generate the encrypted BLOB can be used to decrypt the BLOB.

As noted above, the PIN entry application 120 may generate the encrypted BLOB based on a selected one of multiple dynamic keys provisioned 202b to the PIN entry application 120, wherein the dynamic key used to generate the encrypted BLOB is selected based on a counter. The transaction service provider system 110 may employ a corresponding counter that is cycled each time a decryption corresponding to the token and/or PAN is performed. Thus, the transaction service provider system 110 can be configured to identify which one of the multiple dynamic keys provisioned 202b to the PIN entry application 120 should be used to decrypt the encrypted BLOB.

As noted above, the PIN entry application 120 may generate the encrypted BLOB based on a session key that is generated from a dynamic key provisioned 202b to the PIN entry application 120, wherein the session key is generated from the dynamic key based on a counter. The transaction service provider system 110 may employ a corresponding counter that is cycled each time a decryption corresponding to the token and/or PAN is performed. Thus, based on the counter, the transaction service provider system 110 can be configured to generate the same session key from the dynamic key provisioned 202b to the PIN entry application 120. Further, the transaction service provider system 110 can decrypt the encrypted BLOB based on the session key.

As noted above, the transaction service provider system 110 can include a hardware security module (HSM) 118. According to some aspects of the transaction process 200, the HSM 118 module can perform any one or more of the processes described herein for decrypting the encrypted BLOB. For example, the HSM 118 can be configured to map the PAN extracted from the authorization request communicated by the acquirer system 112 to the token. As another example, the HSM 118 can be configured to identify and/or retrieve the dynamic key(s) associated with the token. As yet another example, the HSM 118 can employ the cryptographic algorithm to decrypt the encrypted BLOB based on the dynamic key(s). Additionally or alternatively, the HSM 118 module can be configured to generate the token(s) and/or dynamic key(s) that are provisioned 202b to the PIN entry application.

Referring still primarily to FIG. 2, and also to FIG. 1, according to the transaction process 200, the transaction service provider system 110 can be configured to communicate 216 an authorization request that includes the PIN to the issuer system 108. As noted above, the transaction service provider system 110 can determine the PIN by decrypting the encrypted BLOB. In some aspects, the transaction service provider system 110 (e.g., the HSM 118) can re-encrypt the PIN and include the re-encrypted PIN in the authorization request communicated 216 to the issuer system 108. The issuer system 108 can be configured to decrypt the re-encrypted PIN. The re-encryption of the PIN by the transaction service provider system 110 and the decryption of the re-encrypted PIN by the issuer system 108 can be performed according to existing PIN encryption and decryption methods employed across transaction service provider and issuer systems.

According to the transaction process 200, based the communication 216 of the authorization request from the transaction service provider system 110, the issuer system 108 can determine whether to authorize the transaction. For example, if the correct PIN has been provided and other transaction-related considerations are satisfied (e.g., sufficient funds, etc.) the issuer system 108 may approve the transaction. If the transaction is approved, the issuer system 108 can respond to the transaction service provider system 110 with a communication indicating that the transaction is approved. This approval can be forwarded to the point-of-sale application 122 (e.g., via the acquirer system 112 and/or the payment gateway system 102). Based on receiving the communication indicating that the transaction is approved, the point-of-sale application 122 may provide a notification to the merchant indicating that the transaction is approved. For example, FIG. 4B illustrates a display screen 400 of the merchant portable electronic device 114 displaying a merchant interface 402b generated by the merchant portable electronic device 114. The merchant interface 402b includes a notification 410 indicating that the transaction is approved.

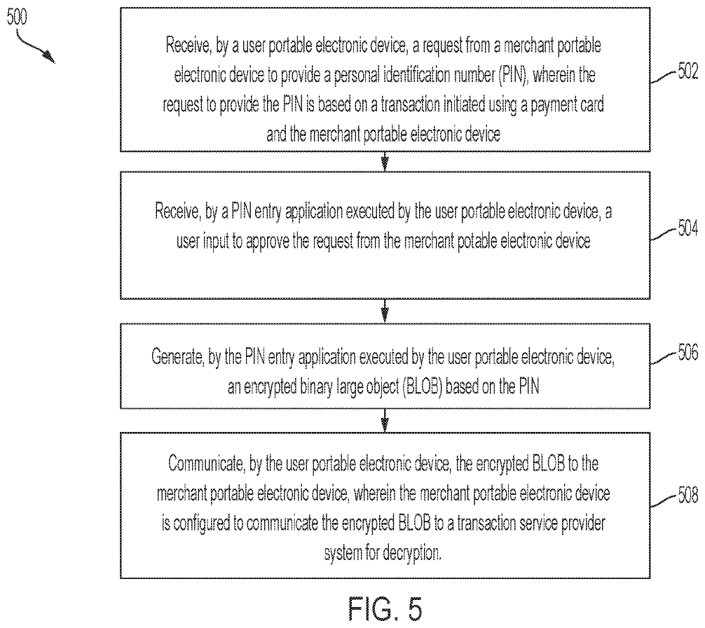

FIG. 5 is a flow diagram of a method 500 for securely providing a PIN, according to at least one aspect of the present disclosure. The method 500 may be carried out by a user portable electronic device, such as the user portable electronic device 106 of FIG. 1. As described further herein with respect to FIGS. 1-2, the user portable electronic device 106 can communicate with a transaction service provider system 110 and a point-of-sale device 104, such as the merchant portable electronic device 114. A user may own or otherwise be associated with the user portable electronic device 106 and a payment card 116. A transaction may be initiated between the user and the merchant using the payment card 116 and the merchant portable electronic device 114. The user portable electronic device 106 can execute a PIN entry application 120.

Referring primarily to FIG. 5, and also to FIG. 1, according to the method 500, the user portable electronic device 106 receives 502 a request from the merchant portable electronic device 114 to provide a PIN. The request from the merchant portable electronic device 114 to provide the PIN can be based on the transaction initiated using a payment card 116 and the merchant portable electronic device 114.

Referring still primarily to FIG. 5, and also to FIG. 1, according to the method 500, the PIN entry application executed by the user portable electronic device 106 receives 504 a user input to approve the request from the merchant portable electronic device 114.

According to some aspects of the method 500, receiving 504 the user input can include receiving, by the user portable electronic device 106, the PIN. For example, as described further with respect to FIG. 3B, a user interface (e.g., a touch screen) of the user portable electronic device 106 may receive the PIN entered by the user.

According to other aspects of the method 500, receiving 504 the user input can include receiving, by the user portable electronic device 106, a passcode. For example, as described further with respect to FIGS. 1-2, the PIN may already be stored by the user portable electronic device 106. The user portable electronic device 106 can be configured authorize the transaction based on receiving (e.g., via a user interface such as a touch screen) a passcode that is different from the PIN and subsequently provide the stored PIN to the merchant portable electronic device 114, as explained further herein.

According to yet other aspects of the method 500, receiving 504 the user input can include receiving, by the user portable electronic device 106, a user biometric authentication. For example, as described further with respect to FIG. 1-2, the PIN may already be stored by the user portable electronic device 106. The user portable electronic device 106 can be configured authorize the transaction based on receiving a biometric authentication (e.g., facial recognition, fingerprint scanning) and subsequently provide the stored PIN to the merchant portable electronic device 114, as explained further herein.

Referring again primarily to FIG. 5, and also to FIG. 1, according to the method 500, the PIN entry application executed by the user portable electronic device 106 generates 506 an encrypted binary large object (BLOB) based on the PIN. According to some aspects of the method 500, the encrypted BLOB is configured according to International Organization for Standardization (ISO) PIN block format.

Referring still primarily to FIG. 5, and also to FIG. 1, according to the method 500, the user portable electronic device 106 communicates 508 the encrypted BLOB to the merchant portable electronic device 114. The merchant portable electronic device 114 can be configured to communicate the encrypted BLOB to the transaction service provider system 110 for decryption.

According to some aspects of the method 500, communicating 508 the encrypted BLOB to the merchant portable electronic device 114 can include generating, by the PIN entry application executed by the user portable electronic device 106, a quick response (QR) code based on the encrypted BLOB and displaying, by a display screen of the user portable electronic device 106, the QR code. The QR code can be readable by the merchant portable electronic device 114, for example, using a camera of the merchant portable electronic device 114.

According to other aspects of the method 500, communicating 508 the encrypted BLOB to the merchant portable electronic device 114 can include generating, by the PIN entry application executed by the user portable electronic device 106, a near field communication (NFC) data exchange format message comprising the encrypted BLOB and transmitting, by the user portable electronic device 106, the NFC data exchange format message comprising the encrypted BLOB to the merchant portable electronic device 114.

According to yet other aspects of the method 500, communicating 508 the encrypted BLOB to the merchant portable electronic device 114 can include generating, by the PIN entry application executed by the user portable electronic device 106, a sound comprising the encrypted BLOB and transmitting the sound comprising the encrypted BLOB to the merchant portable electronic device 114.

According to yet other aspects of the method 500, communicating 508 the encrypted BLOB to the merchant portable electronic device 114 can include generating, by the PIN entry application executed by the user portable electronic device 106, a Bluetooth message comprising the encrypted BLOB and transmitting the Bluetooth message comprising the encrypted BLOB to the merchant portable electronic device 114.

According to yet other aspects of the method 500, communicating 508 the encrypted BLOB to the merchant portable electronic device 114 can include generating, by the PIN entry application executed by the user portable electronic device 106, a WiFi message comprising the encrypted BLOB and transmitting the WiFi message comprising the encrypted BLOB to the merchant portable electronic device 114.

According to some aspects of the method 500, the transaction initiated using the payment card 116 and the merchant portable electronic device 114 is a tap-to-pay and/or a tap-to-phone (e.g., a contactless) transaction.

According to some aspects of the method 500, the encrypted BLOB is generated 506 based on a token provisioned by the transaction service provider system 110 and a dynamic key provisioned by transaction service provider system 110. The transaction service provider server can be configured to subsequently decrypt the encrypted BLOB based on the token and the dynamic key. In one aspect, the PIN entry application executed by the user portable electronic device 106 can enroll the payment card 116 to the PIN entry application (e.g., based on a user input prior to initiating the transaction). The PIN entry application executed by the user portable electronic device 106 can receive the token and the dynamic key provisioned by the transaction service provider system 110. The token and the dynamic key provisioned by the transaction service provider system 110 can be used to generate 506 the encrypted BLOB.

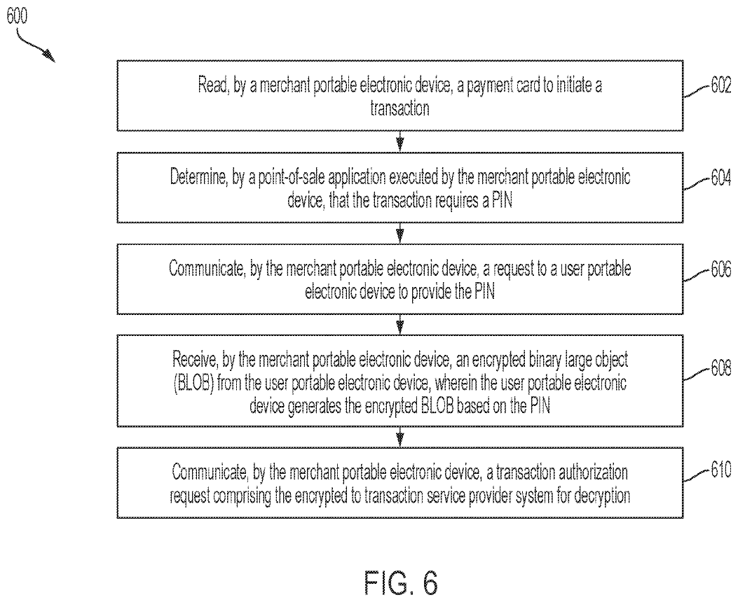

FIG. 6 is a flow diagram of a method 600 for securely receiving a PIN, according to at least one aspect of the present disclosure. The method 600 may be carried out by a merchant portable electronic device, such as the merchant portable electronic device 114 of FIG. 1. As described further herein with respect to FIGS. 1-2, the merchant portable electronic device 114 can communicate with a payment card 116, a user portable electronic device 106, a payment gateway system 102, an acquirer system 112, a transaction service provider system 110, and/or an issuer system 108. The merchant portable electronic device 114 can execute a point-of-sale application 122.

Referring primarily to FIG. 6, and also to FIG. 1, according to the method 600, the merchant portable electronic device 114 reads 602 the payment card 116 to initiate a transaction. According to some aspect of the method 600, the merchant portable electronic device 114 wirelessly reads 602 the payment card 116 (e.g., the transaction can be a contactless and/or tap-to-phone (TTP) transaction).

Referring still primarily to FIG. 6, and also to FIG. 1, according to the method 600, the point-of-sale application 122 executed by the merchant portable electronic device 114 determines 604 that the transaction requires a PIN. Based on determining 604 that the transaction requires a PIN, the merchant portable electronic device 114 communicates 606 a request to the user portable electronic device 106 to provide the PIN.

Referring still primarily to FIG. 6, and also to FIG. 1, according to the method 600, the merchant portable electronic device 114 receives 608 an encrypted binary large object (BLOB) from the user portable electronic device 106. The user portable electronic device can generate the encrypted BLOB based on the PIN.

According to one aspect of the method 600, receiving 608 the encrypted BLOB from the user portable electronic device 106 can include capturing, by a camera of the merchant portable electronic device 114 an image of a quick response (QR) code and extracting the encrypted BLOB based on the image of the QR code. The QR code can be generated by the user portable electronic device based on the encrypted BLOB and displayed by a display screen of the user portable electronic device so that the merchant portable electronic device 114 can capture the image.

According to another aspect of the method 600, receiving 608 the encrypted BLOB from the user portable electronic device 106 can include receiving, by the merchant portable electronic device, a wireless communication comprising the encrypted BLOB from the user portable electronic device, wherein the wireless communication comprises at least one of a near field communication (NFC) data exchange format message, a sound, a Bluetooth message, a WiFi message, or a combination thereof.

Referring still primarily to FIG. 6, and also to FIG. 1, according to the method 600, the merchant portable electronic device 114 communicates 610 the transaction authorization request comprising encrypted BLOB to a transaction service provider system 110 for decryption.

According to one aspect of the method, communicating 610 the transaction authorization request comprising encrypted BLOB to the transaction service provider system 110 can include transmitting, by the merchant portable electronic device 114, a first transaction authorization comprising the encrypted BLOB to the payment gateway system 102. The payment gateway system 102 can then transmit a second transaction authorization comprising the encrypted BLOB to the acquirer system 112. The acquirer system 112 can then transmit a third transaction authorization comprising the encrypted BLOB to the transaction service provider system 110.

According to another aspect of the method, communicating 610 the transaction authorization request comprising encrypted BLOB to the transaction service provider system 110 can include transmitting, by the merchant portable electronic device 114, a first transaction authorization comprising the encrypted BLOB to the acquirer system 112. The acquirer system 112 can then transmit a second transaction authorization comprising the encrypted BLOB to the transaction service provider system 110.

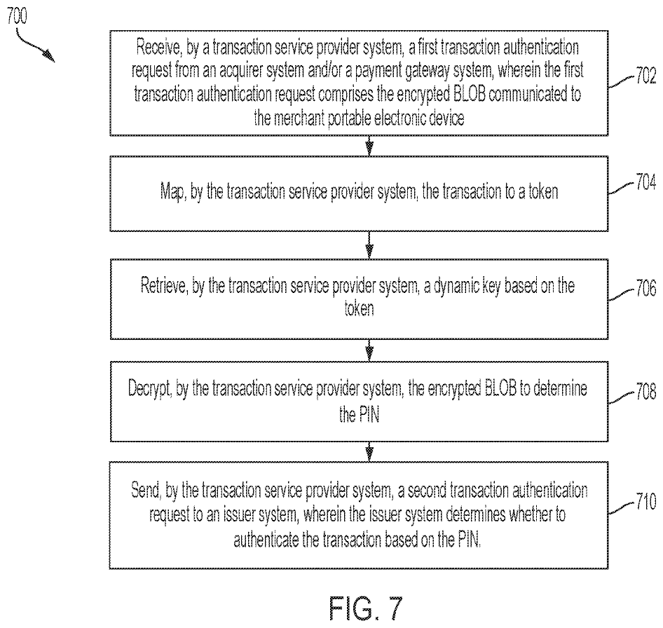

FIG. 7 is a flow diagram of a method 700 for authenticating a transaction based on a securely provided PIN, according to at least one aspect of the present disclosure. The method 700 may be carried out by a transaction service provider server, such as the transaction service provider system 110 of FIG. 1. As described further herein with respect to FIGS. 1-2, a transaction may be initiated using a payment card 116 and a merchant portable electronic device 114. The transaction may require user authentication based on a PIN. A user of the payment card 116 may use a user portable electronic device 106 to generate an encrypted binary large object (BLOB) based on the PIN and communicate the encrypted BLOB to the merchant portable electronic device 114, for example, according to the method 500 described herein with respect to FIG. 5. The merchant portable electronic device 114 may communicate the encrypted BLOB to a payment gateway system 102 and/or an acquirer system 112. The transaction service provider system 110 can be in communication with the user portable electronic device 106, the payment gateway system 102, the acquirer system 112, an issuer system 108 and/or the merchant portable electronic device 114.

Referring primarily to FIG. 7, and also to FIG. 1, according to the method 700, the transaction service provider system 110 receives 702 a first transaction authentication request from the acquirer system 112 and/or the payment gateway system 102. The first transaction authentication request can include the encrypted BLOB communicated by the user portable electronic device 106 to the merchant portable electronic device 114.

According to some aspects of the method 700, the transaction service provider system 110 can determine that the transaction is a tap-to-phone (TTP) transaction based on a TTP transaction identifier comprised in the first transaction authentication request.

Referring primarily to FIG. 7, and also to FIG. 1, according to the method 700, the transaction service provider system 110 maps 704 the transaction to a token. According to some aspects of the method 700, the transaction service provider system 110 extracts a personal authentication number (PAN) from the first transaction authentication request. The transaction service provider system 110 can map 704 the transaction to the token is based on the PAN.

Referring primarily to FIG. 7, and also to FIG. 1, according to the method 700, the transaction service provider system 110 retrieves 706 a dynamic key based on the token.

Referring primarily to FIG. 7, and also to FIG. 1, according to the method 700, the transaction service provider system 110 decrypts 708 the encrypted BLOB to determine the PIN.

Referring primarily to FIG. 7, and also to FIG. 1, according to the method 700, the transaction service provider system 110 sends 710 a second transaction authentication request to the issuer system 108. The issuer system 108 can determine whether to authenticate the transaction based on the PIN.

According to some aspects of the method 700, sending 710 the second transaction authentication request the issuer system 108 can include encrypting, by the transaction service provider system 110, the PIN to generate a re-encrypted PIN and sending, by the transaction service provider system 110, the re-encrypted PIN to the issuer system 108. The issuer system 108 can be configured to decrypt the re-encrypted PIN.

According to some aspects of the method 700, the transaction service provider system 110 provisions the token and the dynamic key to the user portable electronic device 106 (e.g., prior to the transaction) and the user portable electronic device 106 generates the encrypted BLOB based on the token and the dynamic key.

According to some aspects of the method 700, the transaction service provider system 110 includes hardware security module (HSM) 118. In one aspect, mapping 704 the transaction to the token is performed by the HSM 118. In another aspect, retrieving 706 the dynamic key is performed by the HSM 118. In yet another aspect, decrypting 708 the encrypted BLOB to determine the PIN is performed by the HSM 118.

According to some aspects of the method 700, the encrypted BLOB is configured according to International Organization for Standardization (ISO) PIN block format.

FIG. 8 is a block diagram of a portable electronic device 2000, according to at least one aspect of the present disclosure. In some aspects, the portable electronic device 2000 can be the user portable electronic device 106 and/or the merchant portable electronic device 114 described above with respect to FIGS. 1-2. The portable electronic device 2000 includes processor 2002 that can communication via a data bus 2026 with various components such as a memory 2004, a display 2006, a network interface 2008, a speaker 2010, a microphone 2012, a camera 2014, a near field communication (NFC) antenna 2016, a Bluetooth antenna 2018, a WiFi antenna 2020, a biometric authentication module 2022, and/or external interface 2024.

The memory 2004 can store an application 2028 and may store other applications and/or programs such as an operating system. In aspects where the portable electronic device 2000 is the merchant portable electronic device 114 (FIGS. 1-2) the application 2028 can include the point-of-sale application 122 described further herein. In aspects where the portable electronic device 2000 is the user portable electronic device 106 (FIGS. 1-2), the application 2028 can include the PIN entry application 120 described further The display 2006 may be or include a touch screen capable of presenting information to and receiving input from a user and/or a merchant. For example, the display 2006 can generate any of the interface screens described with respect to FIGS. 3A-3C and FIGS. 4A-4B.

The network interface 2008, the NFC antenna 2016, the Bluetooth antenna 2018, and the WiFi antenna 2020 may each support wireless communication. For example, the network interface 2008 can be configured to support cellular communication, the NFC antenna 2016 can be configured to support short-range radio communication, the Bluetooth antenna 2018 can be configured to support Bluetooth communication, and the WiFi antenna 2020can be configured to support WiFi communication. In some aspects, the NFC antenna 2016 can generate an electric field to power an integrated chip of a payment card. For example, in aspects where the portable electronic device 2000 is the merchant portable electronic device 114 (FIGS. 1-2) the NFC antenna 2016 can be configured to communicate with an integrated chip of the payment card 116 to accept contactless payment from the payment card 116.

The biometric authentication module 2022 can be configured to analyze a physical feature of a user (e.g., as a fingerprint of the user, facial features of the user captured by the camera 2014, the user's voice captured by the speaker 2010) to confirm the user's identity. In aspects where the portable electronic device 2000 is the user portable electronic device 106 (FIGS. 1-2), the PIN entry application 120 (e.g., application 2028) can be configured approve a request from the merchant portable electronic device 114 to provide a PIN based on the biometric authentication module 2022 confirming the user's identity.

The external interface 2024 can be configured to connect the portable electronic device 2000 with various other hardware accessories. For example, in aspects where the portable electronic device 2000 is the merchant portable electronic device 114 (FIGS. 1-2), hardware accessories such as an external payment card reader (e.g., a contactless payment card reader configured for NFC communication, a magnetic strip reader) may be connected to the portable electronic device 2000 via the eternal interface 2024.

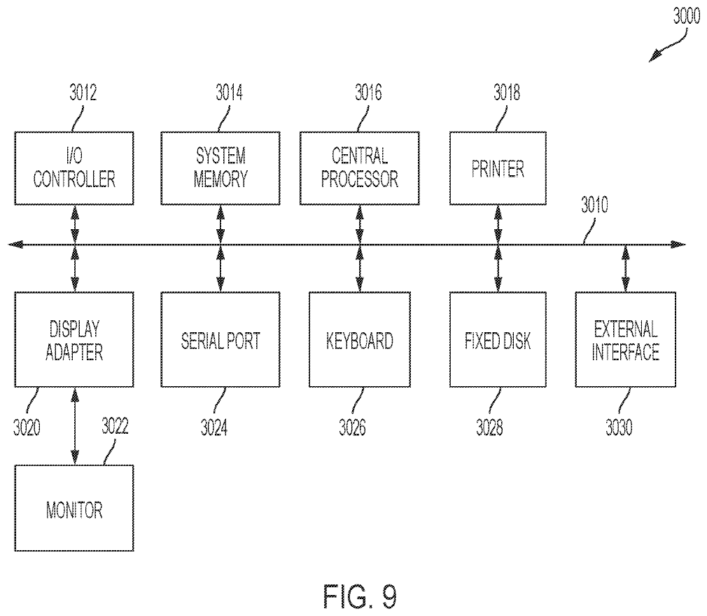

FIG. 9 is a block diagram of a computer apparatus 3000 comprising data processing subsystems or components, according to at least one aspect of the present disclosure. The subsystems shown in FIG. 9 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

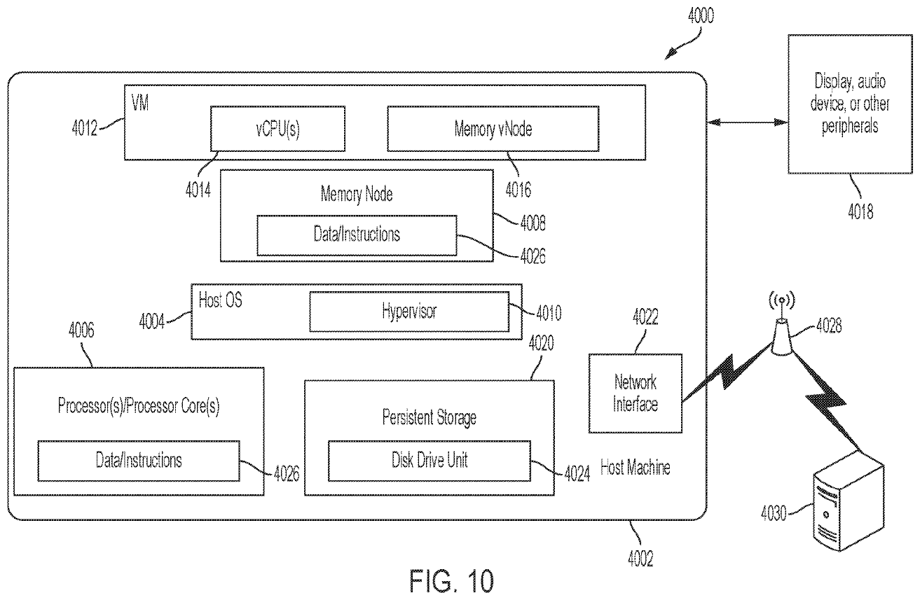

FIG. 10 is a diagrammatic representation of an example computing system 4000 that includes a host machine 4002 within which a set of instructions to perform any one or more of the methodologies discussed herein may be executed, such as, for example, the method 700 of FIG. 7, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment.

The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to the corresponding vNode 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4028 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM.

Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the devices, systems, and methods according to various aspects of the present disclosure are provided below in the following numbered clauses. An aspect of any of the devices(s), method(s) and/or system(s) may include any one or more than one, and any combination of, the numbered clauses described below.
Clause 1: A method for securely providing a personal identification number (PIN), the method comprising: receiving, by a user portable electronic device, a request from a merchant portable electronic device to provide the PIN, wherein the request to provide the PIN is based on a transaction initiated using a payment card and the merchant portable electronic device; receiving, by a PIN entry application executed by the user portable electronic device, a user input to approve the request from the merchant portable electronic device; generating, by the PIN entry application executed by the user portable electronic device, an encrypted binary large object (BLOB) based on the PIN; and communicating, by the user portable electronic device, the encrypted BLOB to the merchant portable electronic device, wherein the merchant portable electronic device is configured to communicate the encrypted BLOB to a transaction service provider server for decryption.
Clause 2: The method of Clause 1, wherein the transaction is a tap-to-phone transaction.
Clause 3: The method of any of Clauses 1-2, wherein receiving the user input comprises at least one of: receiving, by the user portable electronic device, the PIN; receiving, by the user portable electronic device, a passcode; receiving, by the user portable electronic device, a user biometric authentication; or a combination thereof.
Clause 4: The method of any of Clauses 1-3, wherein communicating the encrypted BLOB to the merchant portable electronic device comprises: generating, by the PIN entry application executed by the user portable electronic device, a quick response (QR) code based on the encrypted BLOB; and displaying, by a display screen of the user portable electronic device, the QR code, wherein the QR code is readable by the merchant portable electronic device.
Clause 5: The method of any of Clauses 1-4, wherein communicating the encrypted BLOB to the merchant portable electronic device comprises: generating, by the PIN entry application executed by the user portable electronic device, at least one of a near field communication (NFC) data exchange format message comprising the encrypted BLOB, a sound comprising the encrypted BLOB, a Bluetooth message comprising the encrypted BLOB, a WiFi message comprising the encrypted BLOB, or a combination thereof; and transmitting, by the user portable electronic device, the at least one of the near field communication (NFC) data exchange format message comprising the encrypted BLOB, the sound comprising the encrypted BLOB, the Bluetooth message comprising the encrypted BLOB, the WiFi message comprising the encrypted BLOB, or a combination thereof to the merchant portable electronic device.
Clause 6: The method of any of Clauses 1-5, wherein generating the encrypted BLOB based on the PIN comprises: generating, by the PIN entry application executed by the user portable electronic device, the encrypted BLOB based on a token provisioned by the transaction service provider server and a dynamic key provisioned by the transaction service provider server, wherein the transaction service provider server is configured to decrypt the encrypted BLOB based on the token and the dynamic key.
Clause 7: The method of Clause 6, further comprising: enrolling, by the PIN entry application executed by the user portable electronic device, the payment card to the PIN entry application based on a user input; and receiving, by the PIN entry application executed by the user portable electronic device, the token and the dynamic key provisioned by the transaction service provider server.
Clause 8: The method of any of Clauses 1-7, further comprising: storing, by the PIN entry application executed by the user portable electronic device, the PIN to a memory of the user portable electronic device.
Clause 9: The method of any of Clauses 1-8, wherein the encrypted BLOB is configured according to International Organization for Standardization (ISO) PIN block format.
Clause 10: A method for authenticating a transaction, wherein the transaction is initiated using a payment card and a merchant portable electronic device, wherein the transaction requires authentication based on a personal identification number (PIN), and wherein an encrypted binary large object (BLOB) generated by a user portable electronic device based on the PIN is communicated to the merchant portable electronic device for authenticating the transaction, the method comprising: receiving, by a transaction service provider server, a first transaction authentication request from an acquirer server, wherein the first transaction authentication request comprises the encrypted BLOB communicated to the merchant portable electronic device; mapping, by the transaction service provider server, the transaction to a token; retrieving, by the transaction service provider server, a dynamic key based on the token; decrypting, by the transaction service provider server, the encrypted BLOB to determine the PIN; and sending, by the transaction service provider server, a second transaction authentication request to an issuer server, wherein the issuer server determines whether to authenticate the transaction based on the PIN.
Clause 11: The method of Clause 10, further comprising: determining, by the transaction service provider server, that the transaction is a tap-to-phone transaction (TTP) based on a TTP transaction identifier comprised in the first transaction authentication request.
Clause 12: The method of any of Clauses 10-11, further comprising: provisioning, by the transaction service provider server, the token and the dynamic key to the user portable electronic device, wherein the user portable electronic device generates the encrypted BLOB based on the token and the dynamic key.
Clause 13: The method of Clauses 10-12, wherein sending the second transaction authentication request to the issuer server comprises: encrypting, by the transaction service provider server, the PIN to generate a re-encrypted PIN; and sending, by the transaction service provider server, the re-encrypted PIN to the issuer server, wherein the issuer server is configured to decrypt the re-encrypted PIN.
Clause 14: The method of Clauses 10-13, further comprising: extracting, by the transaction service provider server, a personal authentication number (PAN) from the first transaction authentication request, wherein mapping the transaction to the token is based on the PAN.
Clause 15: The method of Clauses 10-14, wherein the transaction service provider server comprises a hardware security module (HSM), the method further comprising: mapping, by the HSM, the transaction to a token; retrieving, by the HSM, the dynamic key based on the token; and decrypting, by the HSM, the encrypted BLOB to
Clause 16: The method of Clauses 10-15, wherein the encrypted BLOB is configured according to International Organization for Standardization (ISO) PIN block format.
Clause 17: A method for securely receiving a personal identification number (PIN), the method comprising: reading, by a merchant portable electronic device, a payment card to initiate a transaction; determining, by a point-of-sale application executed by the merchant portable electronic device, that the transaction requires a PIN; communicating, by the merchant portable electronic device, a request to a user portable electronic device to provide the PIN; receiving, by the merchant portable electronic device, an encrypted binary large object (BLOB) from the user portable electronic device, wherein the user portable electronic device generates the encrypted BLOB based on the PIN; and communicating, by the merchant portable electronic device, a transaction authorization request comprising the encrypted BLOB to a transaction service provider server for decryption.
Clause 18: The method of Clause 17, wherein communicating the transaction authorization request comprising the encrypted BLOB to a transaction service provider server for decryption comprises one of: transmitting, by the merchant portable electronic device, a first transaction authorization comprising the encrypted BLOB to a payment gateway server, wherein the payment gateway server transmits a second transaction authorization comprising the encrypted BLOB to an acquirer server, and wherein the acquirer server transmits a third transaction authorization comprising the encrypted BLOB to the transaction service provider server; or transmitting, by the merchant portable electronic device, a first transaction authorization comprising the encrypted BLOB to an acquire server, and wherein the acquirer server transmits a second transaction authorization comprising the encrypted BLOB to the transaction service provider server.
Clause 19: The method of any of Clauses 17-18, wherein receiving the encrypted binary large object (BLOB) from the user portable electronic device comprises: capturing, by a camera of the merchant portable electronic device, an image of a quick response (QR) code, wherein the QR code is generated by the user portable electronic device based on the encrypted BLOB, and wherein the QR code is displayed by a display screen of the user portable electronic device; and extracting, by the point-of-sale application executed by the merchant portable electronic device, the encrypted BLOB based on the image of the QR code.
Clause 20: The method of any of Clauses 17-19, wherein receiving the encrypted BLOB from the user portable electronic device comprises: receiving, by the merchant portable electronic device, a wireless communication comprising the encrypted BLOB from the user portable electronic device, wherein the wireless communication comprises at least one of a near field communication (NFC) data exchange format message, a sound, a Bluetooth message, a WiFi message, or a combination thereof.

Further, it is understood that any one or more of the following-described forms, expressions of forms, examples, can be combined with any one or more of the other following-described forms, expressions of forms, and examples.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

The term “substantially”, “about”, or “approximately” as used in the present disclosure, unless otherwise specified, means an acceptable error for a particular value as determined by one of ordinary skill in the art, which depends in part on how the value is measured or determined. In certain aspects, the term “substantially”, “about”, or “approximately” means within 1, 2, 3, or 4 standard deviations. In certain aspects, the term “substantially”, “about”, or “approximately” means within 50%, 20%, 15%, 10%, 9%, 8%, 7%, 6%, 5%, 4%, 3%, 2%, 1%, 0.5%, or 0.05% of a given value or range.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A method for securely providing a personal identification number (PIN), the method comprising:
receiving, by a user portable electronic device, a request from a merchant portable electronic device to provide the PIN, wherein the request to provide the PIN is based on a transaction initiated using a payment card and the merchant portable electronic device;
receiving, by a PIN entry application executed by the user portable electronic device, a user input to approve the request from the merchant portable electronic device;
generating, by the PIN entry application executed by the user portable electronic device, an encrypted binary large object (BLOB) based on the PIN; and
communicating, by the user portable electronic device, the encrypted BLOB to the merchant portable electronic device, wherein the merchant portable electronic device is configured to communicate the encrypted BLOB to a transaction service provider server for decryption.

2. The method of claim 1, wherein the transaction is a tap-to-phone transaction.

3. The method of claim 1, wherein receiving the user input comprises at least one of:
receiving, by the user portable electronic device, the PIN;
receiving, by the user portable electronic device, a passcode;
receiving, by the user portable electronic device, a user biometric authentication; or
a combination thereof.

4. The method of claim 1, wherein communicating the encrypted BLOB to the merchant portable electronic device comprises:
generating, by the PIN entry application executed by the user portable electronic device, a quick response (QR) code based on the encrypted BLOB; and
displaying, by a display screen of the user portable electronic device, the QR code, wherein the QR code is readable by the merchant portable electronic device.

5. The method of claim 1, wherein communicating the encrypted BLOB to the merchant portable electronic device comprises:
generating, by the PIN entry application executed by the user portable electronic device, at least one of a near field communication (NFC) data exchange format message comprising the encrypted BLOB, a sound comprising the encrypted BLOB, a Bluetooth message comprising the encrypted BLOB, a WiFi message comprising the encrypted BLOB, or a combination thereof; and
transmitting, by the user portable electronic device, the at least one of the near field communication (NFC) data exchange format message comprising the encrypted BLOB, the sound comprising the encrypted BLOB, the Bluetooth message comprising the encrypted BLOB, the WiFi message comprising the encrypted BLOB, or a combination thereof to the merchant portable electronic device.

6. The method of claim 1, wherein generating the encrypted BLOB based on the PIN comprises:
generating, by the PIN entry application executed by the user portable electronic device, the encrypted BLOB based on a token provisioned by the transaction service provider server and a dynamic key provisioned by the transaction service provider server, wherein the transaction service provider server is configured to decrypt the encrypted BLOB based on the token and the dynamic key.

7. The method of claim 6, further comprising:
enrolling, by the PIN entry application executed by the user portable electronic device, the payment card to the PIN entry application based on a user input; and
receiving, by the PIN entry application executed by the user portable electronic device, the token and the dynamic key provisioned by the transaction service provider server.

8. The method of claim 7, further comprising:
storing, by the PIN entry application executed by the user portable electronic device, the PIN to a memory of the user portable electronic device.

9. The method of claim 8, wherein the encrypted BLOB is configured according to International Organization for Standardization (ISO) PIN block format.

10. A method for authenticating a transaction, wherein the transaction is initiated using a payment card and a merchant portable electronic device, wherein the transaction requires authentication based on a personal identification number (PIN), and wherein an encrypted binary large object (BLOB) generated by a user portable electronic device based on the PIN is communicated to the merchant portable electronic device for authenticating the transaction, the method comprising:
receiving, by a transaction service provider server, a first transaction authentication request from an acquirer server, wherein the first transaction authentication request comprises the encrypted BLOB communicated to the merchant portable electronic device;
mapping, by the transaction service provider server, the transaction to a token;
retrieving, by the transaction service provider server, a dynamic key based on the token;
decrypting, by the transaction service provider server, the encrypted BLOB to determine the PIN; and
sending, by the transaction service provider server, a second transaction authentication request to an issuer server, wherein the issuer server determines whether to authenticate the transaction based on the PIN.

11. The method of claim 10, further comprising:
determining, by the transaction service provider server, that the transaction is a tap-to-phone transaction (TTP) based on a TTP transaction identifier comprised in the first transaction authentication request.

12. The method of claim 10, further comprising:
provisioning, by the transaction service provider server, the token and the dynamic key to the user portable electronic device, wherein the user portable electronic device generates the encrypted BLOB based on the token and the dynamic key.

13. The method of claim 12, wherein sending the second transaction authentication request to the issuer server comprises:
encrypting, by the transaction service provider server, the PIN to generate a re-encrypted PIN; and
sending, by the transaction service provider server, the re-encrypted PIN to the issuer server, wherein the issuer server is configured to decrypt the re-encrypted PIN.

14. The method of claim 10, further comprising:
extracting, by the transaction service provider server, a personal authentication number (PAN) from the first transaction authentication request, wherein mapping the transaction to the token is based on the PAN.

15. The method of claim 10, wherein the transaction service provider server comprises a hardware security module (HSM), the method further comprising:
mapping, by the HSM, the transaction to a token;
retrieving, by the HSM, the dynamic key based on the token; and
decrypting, by the HSM, the encrypted BLOB to determine the PIN.

16. The method of claim 10, wherein the encrypted BLOB is configured according to International Organization for Standardization (ISO) PIN block format.

17. A method for securely receiving a personal identification number (PIN), the method comprising:
reading, by a merchant portable electronic device, a payment card to initiate a transaction;
determining, by a point-of-sale application executed by the merchant portable electronic device, that the transaction requires a PIN;
communicating, by the merchant portable electronic device, a request to a user portable electronic device to provide the PIN;
receiving, by the merchant portable electronic device, an encrypted binary large object (BLOB) from the user portable electronic device, wherein the user portable electronic device generates the encrypted BLOB based on the PIN; and
communicating, by the merchant portable electronic device, a transaction authorization request comprising the encrypted BLOB to a transaction service provider server for decryption.

18. The method of claim 17, wherein communicating the transaction authorization request comprising the encrypted BLOB to a transaction service provider server for decryption comprises one of:
transmitting, by the merchant portable electronic device, a first transaction authorization comprising the encrypted BLOB to a payment gateway server, wherein the payment gateway server transmits a second transaction authorization comprising the encrypted BLOB to an acquirer server, and wherein the acquirer server transmits a third transaction authorization comprising the encrypted BLOB to the transaction service provider server; or
transmitting, by the merchant portable electronic device, a first transaction authorization comprising the encrypted BLOB to an acquire server, and wherein the acquirer server transmits a second transaction authorization comprising the encrypted BLOB to the transaction service provider server.

19. The method of claim 17, wherein receiving the encrypted binary large object (BLOB) from the user portable electronic device comprises:
capturing, by a camera of the merchant portable electronic device, an image of a quick response (QR) code, wherein the QR code is generated by the user portable electronic device based on the encrypted BLOB, and wherein the QR code is displayed by a display screen of the user portable electronic device; and
extracting, by the point-of-sale application executed by the merchant portable electronic device, the encrypted BLOB based on the image of the QR code.

20. The method of claim 17, wherein receiving the encrypted BLOB from the user portable electronic device comprises:
receiving, by the merchant portable electronic device, a wireless communication comprising the encrypted BLOB from the user portable electronic device, wherein the wireless communication comprises at least one of a near field communication (NFC) data exchange format message, a sound, a Bluetooth message, a WiFi message, or a combination thereof.
